(19) United States
(12) Patent Application Publication
(10) Pub. No.: US 2007/0098952 A1
(43) Pub. Date: May 3, 2007

(54) Extruded laminated floor mat and method of manufacturing same

(76) Inventor: Robert M. Blinstrub, Troy, MI (US)

Correspondence Address: BLISS MCGLYNN, P.C., 2075 WEST BIG BEAVER ROAD, SUITE 600, TROY, MI, 48084, US

(21) Appl. No.: 11/263,513

(22) Filed: Oct. 31, 2005

(51) Int. Cl. B32B 3/02; B32B 33/00

(52) U.S. Cl. 428/95; 428/88; 428/89

(57) ABSTRACT

The present invention relates to a method of manufacturing a floor mat having a dressed edge including extruding material into a sheet that defines the bottom layer of a floor mat. The extruded sheet is bonded to a fabric sheet that defines the top layer of a floor mat where the two layers cooperate to define a laminate. A plurality of nibs is defined on the extruded sheet and a portion of the nibs are subsequently removed through the application of an electromagnetic frequency having a wavelength between 8 kHz and 35,000 MHz to provide at least one smooth area. The laminate is cut into a predetermined shape having a peripheral edge, where the smooth area is disposed along the peripheral edge. The peripheral edge is dressed with a border that conceals the joint between the top layer and the bottom layer and facilitates the bond therebetween.

### BACKGROUND OF THE INVENTION

1. Field of the Invention

The present invention relates, generally, to a method of manufacturing an extruded laminated floor mat for automotive vehicle interiors. More specifically, the present invention relates to an extruded floor mat having a dressed edge and method of manufacturing same.

2. Description of the Related Art

Floor mats that are employed for automotive vehicles typically include a carpeted top layer and a polymer or rubber bottom layer. The bottom layer is often molded (via injection or some other means) and includes a multitude of protrusions commonly referred to as “nibs.” The nibs are employed to provide the necessary coefficient of friction to prevent the floor mat from shifting with respect to the vehicle floor, which is most often carpeted. The carpeted top layer and molded bottom layer are attached via adhesives, needling, or by other method(s) commonly employed in the related art.

Traditionally, the edges of the top and bottom layers were also bound together or dressed by sewing techniques known as “serging” or “tape edging.” These techniques reduce the likelihood of the carpeted top layer separating from the molded bottom layer. Further, floor mats having a serged or taped edge are recognized as having higher quality than floor mats without a dressed edge. Additionally, floor mats having a dressed edge increase the aesthetic value of the floor mat. As a result, floor mats having a dressed edge have become the industry standard.

However, due to added steps in the manufacturing process, dressed floor mats are generally more costly than non-dressed floor mats. Beyond the additional step of applying a serged or taped edge, floor mats having a dressed edge required the additional step of removing the nibs from the area to be dressed. Without providing a smooth, nib-free, area to which the dressing may be applied, the nibs cause aesthetic and quality issues that result in an inferior floor mat. Further, without a smooth area along the bottom layer, OEMs cannot brand the floor mat with desired information, such as logos, part numbers, etc. Thus, while dressed floor mats are preferred, the additional steps necessary to produce a dressed floor mat increase manufacturing costs beyond the ceiling price imposed by most OEM's. As a result of the increased costs, dressed floor mats are available in only high-end vehicles. However, dressed floor mats remain the industry standard for a quality, aesthetically pleasing floor mat.

Certain manufacturing techniques have been proposed to lower the cost of producing a dressed floor mat. Yet, manufacturing techniques of the type known in the related art also suffer from one or more deficiencies. By way of example, one manufacturing technique proposes eliminating the step of removing the nibs from the area of a floor mat to be dressed. However, such a technique results in non-uniform dressing along the edge of the floor mat. More specifically, this technique results in a serged/tape edge having gaps and/or bulge caused by the nibs located along the edge of the floor mat. Another technique proposes reducing the size of the nibs to eliminate the step of removing the nibs and reduce the likelihood of the nibs causing gaps and/or bulges. However, this technique does not eliminate the tendency to create gaps and/or bulges but simply reduces the severity of the gaps and/or bulges. More importantly, this proposed technique reduces the nibs' coefficient of friction for the entire floor mat, thereby increasing the likelihood that it will shift relative to the carpeted interior floor of a vehicle. A shifted driver's side floor mat can create serious safety issues, such as preventing proper application of a vehicle's braking system.

While alternative methods have been proposed, they do not produce the quality floor mat recognized as standard in the industry. Accordingly, there remains a need in the art for a method of manufacturing a floor mat without the nibs at predetermined areas to provide for the application of a dressed edge while reducing associated manufacturing costs. Further, there remains a need in the art for a method of manufacturing a floor mat including a dressed edge and further including a bottom layer having a plurality of nibs that provide the proper coefficient of friction to prevent undesired movement of the floor mat relative to the vehicle floor. Finally, there remains a need in the art for a floor mat having a dressed edge that may be manufactured using a method that reduces production cost to a satisfactory level.

### SUMMARY OF THE INVENTION

The present invention overcomes the disadvantages in the related art and generally fulfills a need in the art for a method of manufacturing a floor mat having a dressed edge with improved aesthetics and quality. To this end, one method of the present invention includes forming a thermoplastic material into an extruded sheet having a first side and a second side opposite the first side. The extruded sheet has a flexible quality when cured and is adapted to define the bottom layer of a floor mat. This method further includes bonding the extruded sheet to a fabric sheet. The fabric sheet is adapted to define the top layer of a floor mat and includes a carpeted super-surface and a scrim subsurface adapted to operatively engage the first side of the extruded sheet. The extruded sheet and the fabric sheet cooperate to define a laminate. This method also includes the step of defining a plurality of nibs extending from the second side of the extruded sheet. The nibs have a predetermined coefficient of friction when operatively engaged to a carpeted interior floor of a vehicle to prevent the floor mat from shifting relative thereto. The next step according to this method of the present invention includes applying an electromagnetic frequency having a wavelength between 8 kHz and 35,000 MHz to a predetermined section of the second side to remove the nibs therefrom and provide at least one smooth area thereon. This method additionally includes the step of cutting the laminated sheet into a predetermined shape having a peripheral edge, where at least one smooth area is disposed along the peripheral edge. Finally, this method of the present invention includes the step of dressing the peripheral edge with a border to provide a floor mat having a dressed edge that conceals the joint between the top layer and the bottom layer and facilitates the bond therebetween.

The present invention is also directed toward another method of manufacturing that includes extruding a thermoplastic material into a sheet having a first side and a second side opposite the first side. The extruded sheet has a flexible quality when cured and is adapted to define the bottom layer of a floor mat. This method includes the step of applying a fabric sheet to the first side of the extruded sheet while the extruded sheet remains tacky. The fabric sheet is adapted to define the top layer of a floor mat and includes a scrim subsurface to operatively engage the first side and a carpeted super-surface. The fabric sheet is then bonded to the extruded sheet in a press to form a laminate. The press includes a surface adapted to impart at least one predetermined design onto the second side of the extruded sheet. The predetermined design includes a plurality of nibs extending from the second side and surrounded by a smooth area. The nibs have a predetermined coefficient of friction when operatively engaged to a carpeted interior floor of a vehicle to prevent the floor mat from shifting relative thereto. This method of the present invention further includes the step of cutting the laminate into at least one predetermined shape corresponding to the predetermined design where the predetermined shape is adapted for use as a vehicle floor mat and wherein the smooth area is disposed along the peripheral edge. Finally, this method of the present invention includes the step of dressing the peripheral edge with a border material to provide a floor mat having a dressed edge that conceals the joint between the top layer and the bottom layer and facilitates the bond therebetween.

The present invention further includes a floor mat for a vehicle interior that is manufactured according a method of the present invention. To this end, the floor mat of the present invention includes an extruded thermoplastic bottom layer having a first side and a second side opposite the first side. The second side includes a plurality of nibs extending therefrom and a smooth area that surrounds the plurality of nibs. The nibs have a predetermined coefficient of friction when operatively engaged to a carpeted interior floor of a vehicle to prevent the floor mat from shifting relative thereto. The nibs are defined on the second side by a mold surface having a plurality of cavities after the application of pressure to the bottom layer while in a mold and while the bottom layer remains tacky. The smooth border is defined on the second side by the application of an electromagnetic frequency having a wavelength between 8 kHz and 35,000 MHz to a predetermined section of the second side to remove the nibs therefrom. The floor mat of the present invention further includes a fabric top layer having a carpeted super-surface defining a Class-A surface that is visible from the interior of a vehicle. The fabric top layer further includes a scrim subsurface bonded to the first side of the bottom layer while the extruded thermoplastic bottom layer remains tacky. The bottom layer and the top layer cooperate to define a predetermined shape having a peripheral edge where the smooth area is disposed adjacent to the peripheral edge. The floor mat of the present invention further includes a fabric border secured to the peripheral edge to provide a dressed edge that conceals the joint between the bottom layer and the top layer and facilitates the bond therebetween.

Accordingly, one advantage of the present invention is that it provides a method of manufacturing a floor mat having a dressed edge, while reducing the manufacturing costs associated therewith to a satisfactory level.

Another advantage of the present invention is that it provides a method of manufacturing a floor mat including a quality and aesthetically pleasing dressed edge while eliminating interference from the nibs.

Still another advantage of the present invention is that it provides method of manufacturing a floor mat having a dressed edge that also includes a plurality of nibs that have a predetermined coefficient of friction to prevent the floor mat from shifting relative to a vehicle interior floor.

Yet another advantage of the present invention is that it provides a floor mat including a serged border and a plurality of nibs having a predetermined coefficient of friction that is produced by a simplified method to reduce the associated manufacturing costs.

Yet another advantage of the present invention is that it provides a floor mat including a tape edge border and a plurality of nibs having a predetermined coefficient of friction that is produced by a simplified method to reduce the associated manufacturing costs.

Other objects, features, and advantages of the present invention will be readily appreciated, as the same becomes better understood, after reading the subsequent description taken in conjunction with the accompanying drawings.

### BRIEF DESCRIPTION OF THE DRAWINGS

FIG. 1 is a perspective view of a floor mat for a vehicle having a serged edge and manufactured according to a method of the present invention;

FIG. 2 is a partial peel-away view of the floor mat illustrated in FIG. 1.

FIG. 3 is a perspective view of a floor mat for a vehicle having taped edge and manufactured according to a method of the present invention.

FIG. 4 is a schematic diagram of a method of manufacturing a floor mat for vehicle according to the present invention.

### DETAILED DESCRIPTION OF THE INVENTION

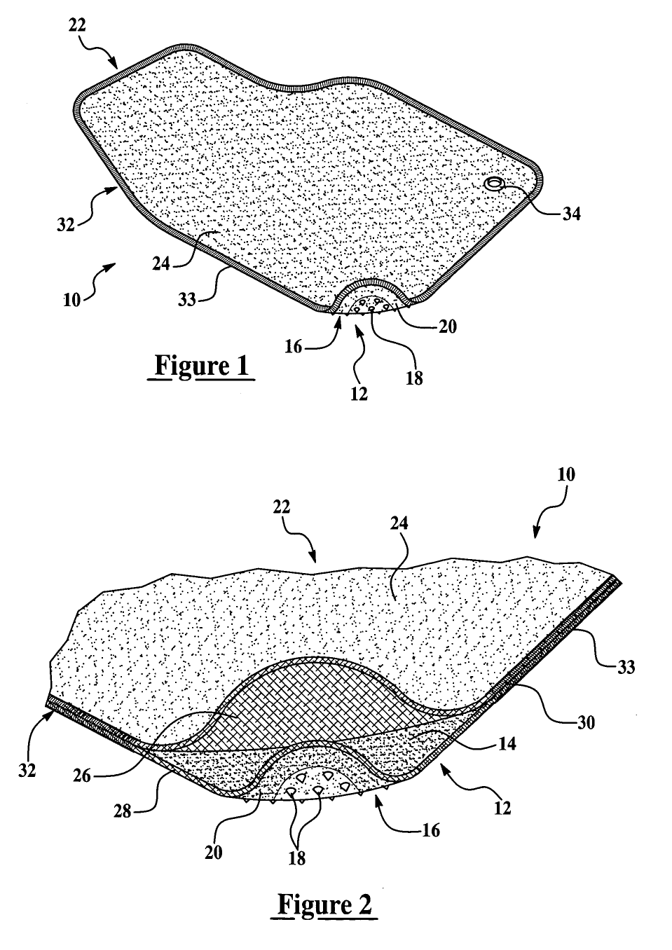

A floor mat of the present invention is generally indicated at 10 in FIGS. 1 and 2, where like numbers are used to designate like structure throughout the figures. The floor mat 10 includes an extruded thermoplastic bottom layer, generally indicated at 12. The thermoplastic material employed for use as the bottom layer 12 provides a flexible quality when cured, such as thermoplastic rubber. However, those having ordinary skill in the art will appreciate that other thermoplastics may be employed to produce the bottom layer 12 of the floor mat 10 of the present invention. By way of example, thermoplastic olefin or a thermoplastic elastomer may be employed to produce the thermoplastic bottom layer 12 of the present invention.

Referring specifically to FIG. 2, the bottom layer 12 includes a first side 14 and a second side, generally indicated at 16. The second side 16 includes a plurality of nibs 18 extending therefrom. The nibs 18 are adapted to operatively engage the interior floor of a vehicle. The floor mat 10 of the present invention is generally adapted for use in a vehicle having a carpeted interior floor. Accordingly, the nibs 18 have a predetermined coefficient of friction when operatively engaged to a carpeted interior floor to prevent the floor mat 10 from shifting. Those having ordinary skill in the art will appreciate that while the floor mat 10 of the present invention is generally adapted for use in a vehicle having a carpeted interior floor, it is not limited to such applications. By way of example, the floor mat 10 of the present invention may be employed for use in a vehicle having a rubber-coated interior floor, such as those found in commercial utility vehicles.

The second side 16 further includes at least one smooth area 20. One smooth area 20 is adapted to substantially surround the plurality of nibs 18 and is also adapted receive a border, as described in greater detail below. Those having ordinary skill in the art will appreciate that while the second side 16 includes at least one smooth area 20, a second smooth area may also be employed. By way of example, the second side 16 may further include a second smooth area to provide branding such as an OEM logo, the name of the vehicle model, part numbers or other identifying information.

The floor mat illustrated in FIGS. 1 and 2 further includes a fabric top layer generally indicated at 22. The fabric top layer 22 includes a carpeted super-surface 24 that defines a class-A surface visible from the interior of a vehicle. Those having ordinary skill in the art will appreciate that the carpeted super-surface 24 may include any form of carpeting having the necessary wear characteristics for use as a vehicle floor mat. By way of example, the carpeted super-surface 24 may include piled carpeting, tufted carpeting, or any other material suitable for a class A surface in a vehicle.

The fabric top layer 22 further includes a scrim subsurface 26 that is bonded to the first side 14 while the extruded thermoplastic bottom layer 12 remains tacky, as will be described in greater detail below. The scrim subsurface 26 is a polymer material, such as nylon, adapted to facilitate a mechanical bond between the top layer 22 and the first side 14 of the extruded thermoplastic bottom layer 12. Those having ordinary skill in the art will appreciate that while the scrim subsurface 26 may include a polymer-based material, other material may be employed to provide a scrim subsurface 26. By way of example, the scrim subsurface 26 may be manufactured from any resilient synthetic polymer or natural fiber that may facilitate a mechanical bond to the first side 14 of the extruded thermoplastic bottom layer 12.

The fabric top layer 22 and the bottom layer 12 cooperate to define a laminate floor mat 10 having a predetermined shape. The dimensions of the predetermined shape will vary depending on the intended application. More specifically, since the area of a vehicle interior floor adapted to receive a floor mat 10 varies among vehicles, the floor mat 10 of the present invention includes a predetermined shape that is adapted to fit in the designated area within a particular vehicle. The predetermined shape of the floor mat 10 includes a peripheral edge 28. The peripheral edge 28 is adapted to receive a fabric border, as will be described in greater detail below. In one embodiment, the smooth area 20 of the second side 16 is disposed adjacent to the peripheral edge 28. As illustrated in FIG. 2, the laminated top layer 22 and bottom layer 12 define a joint 30 that is visible along the peripheral edge 28. Given the conditions to which floor mats are subjected, the peripheral edge 28 is the most common area for separation to occur between the top layer 22 and the bottom layers 12.

As a result, the floor mat 10 of the present invention further includes a border, generally indicated at 32, that is secured to the peripheral edge 28. The border 32 provides a dressed edge to the floor mat 10. The border 32 is adapted to conceal the joint 30 between the bottom layer 12 and the top layer 22 as well as to facilitate the bond between these layers along the peripheral edge 28. In one embodiment illustrated in FIGS. 1 and 2, the border 32 is a serged edge that overlaps a portion of the carpeted super-surface 24 as well as a portion of the smooth area 20 of the second side 16 to conceal the peripheral edge 28 of the predetermined shape. The serged edge includes a thread 33 installed to the floor mat 10 having a predetermined amount of stitches per inch. The serged edge is preferably manufactured from a filament nylon thread 33 that meets certain standards according to the American Society of Testing and Materials active standards (ASTM D1244 and ASTM D 204). More specifically, the serge thread is spun into two separate ends (plies) using a S twist direction. The two plies are twisted together in reverse Z direction and heated to form a continuous single 2808 Denier nylon cord having a minimum tensile strength of 50 N and minimum fade resistance of 112.8 kJ/m². However, those having ordinary skill in the art will appreciate that the serge material and technique employed for use in connection with the floor mat 10 of the present invention may vary. By way of example, the surge material may include a cotton thread and the technique may include stitching a monofilament material having similar strength and fade characteristics as well as any other method and material commonly known in the related art.

The floor mat 10 of the present invention further includes a grommet 34 adapted to operatively engage a hook or other protrusion located within the interior floor of a vehicle. The grommet 34 is manufactured from a metal or polymer and is traditionally employed on floor mats adapted for use in connection with the driver's side of the vehicle. However, those having ordinary skill in the art will appreciate that the floor mat 10 of the present invention may include a grommet 34 on a floor mat for use in connection with the passenger's side of the vehicle. Furthermore, those having ordinary skill in the art will appreciate that the floor mat 10 of the present invention may include an aperture defined by a woven circumferential border as a replacement to a grommet 34. The aperture is adapted to receive a hook or other protrusion located on the vehicle interior floor.

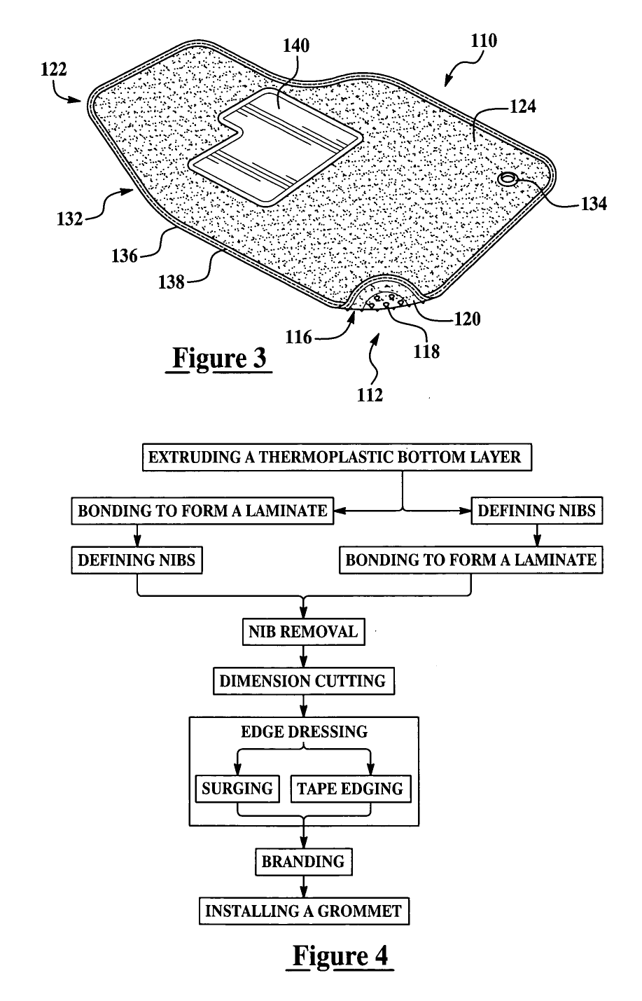

An alternative embodiment of the floor mat 10 of the present invention is generally indicated at 110 in FIG. 3, where like numerals increased by 100 with respect to the embodiment of the invention illustrated in FIGS. 1 and 2, are used to designate like structure. The floor mat 110 of the present invention as shown in FIG. 3 is substantially similar in structure to the floor mat 10 shown in FIGS. 1 and 2. However, the border 32 defined as a serged edge illustrated in FIGS. 1 and 2 is shown as defined by a tape edge in FIG. 3. Specifically in FIG. 3, the border 132 is a tape edge having a fabric binding tape 136 disposed along the peripheral edge 128 of the predetermined shape. The tape edge further includes stitching 138 that secures the fabric binding tape 136 to the peripheral edge 128 and overlaps a portion of the carpeted super-surface 124 as well as a portion of the smooth area 120 of the second side 116 to completely conceal the peripheral edge 128 of the predetermined shape.

The floor mat 110 further includes a heel pad 140 disposed on the carpeted super-surface 124. The heel pad 140 is adapted to provide increased wear resistance at a selected area of the super-surface 124. The heel pad 140 is most commonly employed on a floor mat for use in connection with the driver's side of the vehicle at the area where driver's heel contacts the floor mat. However, those having ordinary skill in the art will appreciate that a heel pad 140 may be included on the carpeted super-surface 124 of the floor mat 110 that is employed for use in connection with the driver's side or the passenger's side of the vehicle.

The floor mat 10, 110 of the present invention is manufactured according to a method of the present invention that is schematically illustrated in FIG. 4. The method of manufacturing a floor mat 10, 110 of the present invention includes extruding a thermoplastic material into a sheet. The extrusion process involves converting thermoplastic resin into a molten thermoplastic material and subsequently extruding the molten material through a horizontally elongated nozzle to provide the extruded sheet having a flexible quality when cured and adapted for use as the bottom layer 12, 112 of the floor mat 10, 110 of the present invention.

The thermoplastic material is extruded into sheet form onto a substrate such as a conveyor or a table. In either event, the extruded sheet is transferred into contact with a fabric sheet adapted to define the top layer 22, 122 of the floor mat 10, 110 of the present invention. The first side 14, 114 of the extruded sheet is placed into contact with the scrim subsurface 26, 126 of the fabric sheet to form a laminate while the extruded sheet is tacky following the extrusion process. More specifically, following the extrusion process, the heat from the extruded sheet will cause the scrim subsurface 26, 126 to adhere to the first side 14, 114 of the extruded sheet, thereby forming a mechanical bond. Where a conveyor is employed to receive the extruded sheet following the extrusion process, the fabric sheet may be placed into contact with the extruded sheet immediately after the extrusion process and as these materials proceed toward subsequent steps in the method of manufacture according to the present invention.

Those having ordinary skill in the art will appreciate that bonding the extruded sheet to the scrim subsurface 26, 126 may also be achieved by placing the scrim subsurface 26, 126 into contact with the first side 14, 114 of the extruded sheet material after applying an adhesive to the first side 14, 114 to define a mechanically bonded laminate. The bonding process may also be achieved by placing the first side 14, 114 of the extruded material into contact with the scrim subsurface 26, 126 after applying an adhesive to the scrim subsurface 26, 126 to define a mechanically bonded laminate. Furthermore, the bonding process may be achieved by placing the scrim subsurface 26, 126 into contact with the first surface 14, 114 of the extruded sheet material after heating at least the first side 14, 114 of the extruded sheet material to define a mechanically bonded laminate.

After the fabric sheet is bonded to the extruded sheet to form the laminate, a plurality of nibs 18, 118 are defined so as to extend from the second side 16, 116 of the extruded sheet. The nibs 18, 118 are defined by placing the laminate into a compressive molding tool having a mold surface including a plurality of cavities while the extruded sheet material remains tacky. Pressure is then applied to direct a portion of the extruded sheet into the plurality of cavities to define a plurality of nibs 18, 118 along the second side 16, 116. The laminate is then removed from the mold cavity. However, those having ordinary skill in the art will appreciate that the compressive mold may be replaced by rollers that apply pressure to define the nibs 18, 118 along the second side 16, 116. In this case, the laminate is positioned between first and second rollers while the extruded sheet remains tacky. One of the rollers includes a plurality of cavities that are adapted to receive a portion of the extruded sheet. The laminate is then cycled between the first and second rollers which pressure the laminate, thereby forcing a portion of the extruded sheet into the plurality of cavities so as to define a plurality of nibs 18, 118 along the second side 16, 116. The laminate having a plurality of nibs 18, 118 is subsequently extracted from between the first and second rollers. Where the method of extruding the thermoplastic sheet includes the use of a conveyor, the application of rollers to define the plurality of nibs is particularly efficient, as the conveyor may immediately direct the laminate into contact with the rollers following the bonding process.

Those having ordinary skill in the art will appreciate that while the step of defining a plurality of nibs 18, 118, as discussed above, occurs after the step of bonding the extruded sheet to the fabric sheet, these steps may occur in the inverse sequence or may also occur simultaneously. Where the step of defining the nibs 18, 118 occurs prior to bonding the extruded sheet to the fabric sheet, only the extruded sheet engages the compressive mold or rollers, rather than exposing the laminate to same. Furthermore, where the above-described steps occur simultaneously, the fabric sheet is bonded to the extruded sheet (while tacky) through the application of pressure to form the laminate while the nibs 18, 118 are defined along the second side 16, 116.

The method of the present invention further includes the step of removing a portion of the nibs 18, 118 from a predetermined section of the second side 16, 116 to define at least one smooth area 20, 120. In one embodiment, the nibs 18, 118 are removed through the application of an electromagnetic frequency having a wavelength between 8 kHz and 35,000 MHz. More specifically, nib removal occurs by placing the second side 16, 116 into contact with the ultrasonic frequency of an ultrasonic welding machine for a predetermined time to melt the nibs 18, 118 within the predetermined section. Alternatively, nib removal may be achieved by placing the second side 16, 116 into contact with the radio frequency of a dielectric welding machine for a predetermined time to melt the nibs 18, 118 within the predetermined section. In either event, a smooth area 20, 120 is defined along the second side 16, 116 that surrounds the remaining plurality of nibs 18, 118. The smooth area 20, 120 surrounding the plurality of nibs 18, 118 is adapted to facilitate the application of a border 32, 132 to provide a dressed edge to the floor mat 10, 110, as described in greater detail below. Those having ordinary skill in the art will appreciate that the predetermined time for contact with either electromagnetic frequency will depend on the degree to which the nibs 18, 118 to be removed have cured, as well as other factors, such as composition of the extruded sheet and ambient temperature.

Prior to the step of removing the nibs 18, 118 from a predetermined section of the second side 16, 116, the laminate may be cut into blanks. The blanks may be cut into any dimension, such as rectangle, by a stamping process or any other process employed to cut a carpet—extruded plastic laminate as commonly known in the related art. By cutting the laminate into blanks having a slightly larger size than the floor mat the difficulties associated with transporting the laminate in bulk to the nib removal process are greatly reduced. However, those having ordinary skill in the art will appreciate that while the laminate may be cut into blanks to increase manufacturing efficiencies, the laminate will be directed toward subsequent steps according to the method of the present invention in any manner that is most efficient. By way of example, where the machines for use in connection with subsequent steps of the method of the present invention can accommodate larger blanks, several blanks or an entire laminate sheet, the need to cut the laminate into a blank corresponding to a single floor mat is eliminated.

Once the nibs 18, 118 are removed through the application of an electromagnetic frequency, the laminate is cut into a specific dimension to define a predetermined shape having a peripheral edge 28, 128. This step in the method of the present invention includes placing the laminate into a mold having a die corresponding to the predetermined shape of at least one floor mat 10, 110 and stamping the shape of the die into the laminate and then removing the laminate from the mold cavity. Alternatively, the step of cutting the laminate into a predetermined shape is accomplished by placing the laminate between first and second rollers where at least one of the rollers includes at least one cutting preform having an outline corresponding to the predetermined shape of at least one floor mat. The laminate is then cycled between the first and second rollers such that the cutting preform cuts the laminate to impart the predetermined shape onto the laminate. The predetermined shape defined by the cutting preform is then extracted from between the first and second rollers. In either event, the laminate is cut into a predetermined shape such that the smooth area 20, 120 along the second side 16, 116 is disposed adjacent the peripheral edge 28, 128.

Following the step of cutting the laminate into a predetermined shape, the method of the present invention further includes dressing the peripheral edge 28, 128 with a border 32, 132 to provide a floor mat 10, 110 having a dressed edge. The dressed edge conceals the joint 30, 130 between the fabric top layer 22, 122 and the extruded bottom layer 12, 112 and is adapted to facilitate the bond between these two layers. This step further includes serging the peripheral edge 28 of the predetermined shape to provide a floor mat 10 having a serged edge border 32. As an alternative to serging, the peripheral edge 128 may include a tape edge border 132. The step of providing this type of border 132 includes applying a fabric binding tape 136 to the peripheral edge 128 of the predetermined shape and stitching the binding tape 136 to the predetermined shape to provide a floor mat 110 having a tape edge border 132. Those having ordinary skill in the art will appreciate that while a fabric binding tape 136 is employed for use in connection with applying a tape edge 132, other material may be employed to accomplish a similar end. By way of example, the step of applying a tape edge 132 may include applying a polymer binding tape or a rubber sleeve to the peripheral edge 128 of the predetermined shape as a replacement to the fabric binding tape 136.

The method of the present invention further includes the step of installing a grommet 34, 134 to operatively engage a hook or other protrusion located on the carpeted floor of a vehicle interior. The grommet 34, 134 may include any commercially available grommet suitable for the intended application. By way of example, the grommet 34, 134 may include a metal or plastic grommet that is mounted to the floor mat 10, 110 of the present invention by press-fitting the grommet 34, 134 into the floor mat 10, 110 at the desired location. Those having ordinary skill in the art will appreciate that while the step of installing a grommet 34, 134 is more frequently employed with respect to floor mats designed for use in connection with the driver's side of the vehicle, the method of the present invention is not limited to such applications. By way of example, the step of installing a grommet 34, 134 may be applied to floor mats designed for use in connection with the passenger's side as well as the driver's side of the vehicle.

The present invention further includes another method of manufacturing a floor mat having a dressed edge. This other method includes extruding a thermoplastic material into an extruded sheet similar to the method described above and illustrated in FIG. 4. A fabric sheet is then applied to the first side 14, 114 of the extruded sheet while the extruded sheet remains tacky. Specifically, the scrim subsurface 26, 126 of the fabric sheet contacts the first side 14, 114 of the extruded sheet while the extruded sheet remains tacky to provide a preliminary bond between these two layers. However, the preliminary bond may also be accomplished after the extruded sheet has cured by heating at least the first side 14, 114 of the extruded sheet to simulate the inert heat possessed by the extruded sheet when tacky and then applying the fabric sheet to the first side 14, 114. Additionally, the preliminary bond may be enhanced through the application of an adhesive applied to either the first side 14, 114 of the extruded sheet or the scrim subsurface 26, 126 of the fabric sheet prior to applying the fabric sheet to the extruded sheet.

Following the application of the fabric sheet to the extruded sheet, the fabric sheet is bonded to the extruded sheet in a press to form a laminate. The press includes a surface adapted to impart at least one predetermined design onto the second side 16, 116 of the extruded sheet. The predetermined design imparted by the surface of press includes a plurality of cavities surrounded by a smooth area. The cavities are adapted to define a plurality of nibs 18, 118 extending from the second side 16, 116 so as to have a predetermined coefficient of friction when operatively engaged to a carpeted interior floor of a vehicle to prevent the floor mat 10, 110 from shifting relative thereto. Accordingly, to impart the predetermined design, the second side 16, 116 must be at least partially tacky.

More specifically, the bonding step includes placing the extruded sheet and fabric sheet between first and second rollers where the surface of one of the rollers includes a mold having at least one predetermined design. The two sheets are cycled between the first and second rollers, such that pressure is applied thereto to define a laminate. The application of pressure further provides that the predetermined design of the mold is imprinted on to the second side 16, 116 of the extruded sheet to define a plurality of nibs 18, 118 surrounded by a smooth area 20, 120. The laminate is then extracted from between the first and second rollers. Those having ordinary skill in the art will appreciate that while the step of bonding the extruded sheet to the fabric sheet to define a laminate has been described with respect to the use of rollers, other manufacturing techniques may be employed to accomplish the same end. By way of example, the extruded sheet and fabric sheet may be laminated so as to have a predetermined design including a plurality of nibs 18, 118 surround by a smooth area 20, 120 by stamping the two layers in a stationary press.

After the step of defining the laminate having a predetermined design, this method of the present invention further includes cutting the laminate into a predetermined shape corresponding to the predetermined design. The predetermined shape corresponds to a vehicle floor mat including a peripheral edge 28, 128 where the smooth area 20, 120 of the predetermined design is disposed adjacent the peripheral edge 28, 128. More specifically, the step of cutting the laminate includes placing the laminate between first and second rollers where at least one of the rollers includes at least one cutting preform having an outline corresponding to the predetermined design. The laminate is they cycled between the first and second rollers, such that the cutting preform cuts the laminate along the outline to define a predetermined shape having a peripheral edge 28, 128 onto the laminate corresponding to the predetermined design. The predetermined shape defined by the cutting preform is then removed from between the first and second rollers.

Those having ordinary skill in the art will appreciate that while the step of cutting the laminate has been described using rollers, other manufacturing techniques may be employed to accomplish the same end. By way of example, the step of cutting the laminate into a predetermined shape may include placing the laminate into a mold having a die corresponding to the predetermined design and stamping the die into the laminate to cut the laminate into at least one predetermined shape having a peripheral edge 28, 128 corresponding to the predetermined design. The predetermined design defined by the die is then removed from the mold.

After cutting the laminate into a predetermined shape, the peripheral edge 28, 129 is dressed with a border material. Dressing the peripheral edge 28, 128 with border material provides a floor mat 10, 110 having a dressed edge that conceals the joint 30, 130 between the top layer 22, 122 and the bottom layer 12, 112 and facilitates the bond between these two layers. More specifically, the dressing the peripheral edge 28 includes serging the peripheral edge 28 to provide a floor mat 10 having a serged edge border 32. Serging includes the sewing technique and material describe above with respect to the method illustrated in FIG. 4 and is incorporated by reference herein. Alternatively, the step of dressing the peripheral edge 128 includes applying a fabric binding tape 136 to the peripheral edge 128 of the predetermined shape and stitching the binding tape 136 to the predetermined shape to provide a floor mat 110 having a tape edge border 132. Further, an alternative to applying a fabric binding tape 136 includes applying a polymer sleeve to the peripheral edge 128 to of the predetermined shape to provide a tape edge border 132 to the floor mat 110.

The present invention provides a method of manufacturing a floor mat 10, 110 having a dressed edge, while reducing the manufacturing costs associated therewith to a satisfactory level. Further, the present invention provides a method of manufacturing a floor mat 10, 110 having a smooth area 20, 120, thereby accommodating the application of a quality and aesthetic dressed edge without encountering interference from the nibs 18, 118. Still further, the method of manufacturing a floor mat 10, 110 according to the present invention includes defining a plurality of nibs 18, 118 that have a predetermined coefficient of friction to prevent the floor mat from shifting relative to a vehicle interior floor. Additionally, the present invention provides a floor mat 10, 110 including a serged border and a plurality of nibs having a predetermined coefficient of friction that is produced by a method of the present invention which reduces manufacturing costs.

The present invention has been described in an illustrative manner. It is to be understood that the terminology that has been used is intended to be in the nature of words of description rather than of limitation. Many modifications and variations of the present invention are possible in light of the above teachings. Therefore, within the scope of the appended claims, the present invention may be practiced other than as specifically described.

1. A method of manufacturing a floor mat for the interior of a vehicle, said method comprising the steps of:
extruding a thermoplastic material into a sheet having a first side and a second side opposite the first side, the extruded sheet having flexible quality when cured and adapted to define the bottom layer of a floor mat;
bonding the extruded sheet to a fabric sheet adapted to define the top layer of a floor mat, the fabric sheet includes a carpeted super-surface and a scrim subsurface adapted to operatively engage the first side of the extruded sheet, the extruded sheet and the fabric sheet cooperate to define a laminate;
defining a plurality of nibs extending from the second side of the extruded sheet, the nibs having a predetermined coefficient of friction when operatively engaged to a carpeted interior floor of a vehicle to prevent the floor mat from shifting relative thereto;
applying an electromagnetic frequency having a wavelength between 8 kHz and 35,000 MHz to a predetermined section of the second side to remove the nibs therefrom and provide at least one smooth area thereon;
cutting the laminate into a predetermined shape having a peripheral edge, wherein at least one smooth area is disposed along the peripheral edge; and
dressing the peripheral edge with a border to provide a floor mat having a dressed edge that conceals the joint between the top layer and the bottom layer and facilitates the bond therebetween.

2. The method as set forth in claim 1 wherein said step of defining the plurality of nibs further includes:
placing the extruded sheet into a compressive molding tool having a mold surface including a plurality of cavities while the extruded sheet remains tacky;
applying pressure so as to fill the plurality of cavities with a portion of the extruded sheet and define a plurality of nibs along the second side; and
removing the extruded sheet from the mold cavity.

3. The method as set forth in claim 1 wherein said step of defining the plurality of nibs further includes the following steps:
placing the extruded sheet between first and second rollers while the extruded sheet remains tacky, at least one of the rollers including a plurality of cavities adapted to receive a portion of the extruded sheet;
cycling the extruded sheet between the first and second rollers, such that pressure is applied to the extruded sheet and a portion thereof operatively engages the plurality of cavities to define a plurality of nibs extending from the second side; and
extracting the extruded sheet from between the first and second rollers.

4. The method as set forth in claim 1 wherein said step of bonding the extruded sheet to the fabric sheet further includes at least one of the following steps:
placing the scrim subsurface into contact with the first side of the extruded sheet after applying an adhesive to the first side to define a mechanically bonded laminate;
placing the first side of the extruded sheet into contact with the scrim subsurface after applying an adhesive to the scrim subsurface to define a mechanically bonded laminate;
placing the scrim subsurface into contact with the first side of the extruded sheet after heating at least the first side of the extruded sheet to define a mechanically bonded laminate; and
placing the extruded sheet into contact with the scrim subsurface while the extruded sheet is tacky following the extrusion process to define a mechanically bonded laminate.

5. The method as set forth in claim 1 wherein said step of defining a plurality of nibs occurs prior to said step of bonding the extruded sheet to the fabric sheet.

6. The method as set forth in claim 1 wherein said step of defining a plurality of nibs occurs simultaneously with said step of bonding the extruded sheet to the fabric sheet.

7. The method as set forth in claim 1 further includes the step of cutting the laminate into at least one blank prior to said step of applying an electromagnetic frequency to facilitate the application of an electromagnetic frequency to a predetermined area of the second side.

8. The method as set forth in claim 1 wherein said step of applying the electromagnetic frequency further includes applying an ultrasonic weld having a frequency between 8 kHz and 17 kHz to the second side of the extruded sheet to melt the nibs within the predetermined section and provide a smooth area adapted to receive a dressed edge.

9. The method as set forth in claim 1 wherein said step of applying the electromagnetic frequency further includes applying a dielectric weld having a radio frequency between 29 kHz and 35,000 MHz to the second side of the extruded sheet to melt the nibs within the predetermined section and provide a smooth area adapted to receive a dressed edge.

10. The method as set forth in claim 1 wherein said step of cutting the laminate into the predetermined shape further includes the steps of:
placing the laminate between first and second rollers where at least one of the rollers includes at least one cutting preform having an outline corresponding to the predetermined shape of at least one floor mat;
cycling the laminate between the first and second rollers, such that the cutting preform cuts the laminate to impart the predetermined shape onto the laminate; and
extracting the predetermined shape defined by the cutting preform from between the first and second rollers.

11. The method as set forth in claim 1 wherein said step of cutting the laminate into the predetermined shape further includes the steps of:
placing the laminate into a mold having a die corresponding to the predetermined shape of at least one floor mat;
stamping the die into the laminate to cut the laminate into at least one predetermined shape; and
removing the predetermined shape defined by the die from the mold.

12. The method as set forth in claim 1 wherein said step of dressing the peripheral edge of the predetermined shape further includes the step of serging the peripheral edge of the predetermined shape to provide a floor mat having a serged edge border.

13. The method as set forth in claim 1 wherein said step of dressing the peripheral edge of the predetermined shape further includes the steps of:
applying a fabric binding tape to the peripheral edge of the predetermined shape; and
stitching the binding tape to the predetermined shape to provide a floor mat having a tape edge border.

14. The method as set forth in claim 1 further includes the step of installing a grommet adapted to receive a protrusion located on the carpeted floor of a vehicle interior to further prevent the floor mat from shifting relative thereto.

15. A method of manufacturing a floor mat for the interior of a vehicle, said method comprising the steps of:
extruding a thermoplastic material into a sheet having a first side and a second side opposite the first side, the extruded sheet having flexible quality when cured and adapted to define the bottom layer of a floor mat;
applying a fabric sheet to the first side of the extruded sheet while the extruded sheet remains tacky, the fabric sheet is adapted to define the top layer of a floor mat and includes a scrim subsurface to operatively engage the first side and a carpeted super-surface;
bonding the fabric sheet to the extruded sheet in a press to form a laminate, the press including a surface having a plurality of cavities adapted to define a plurality of nibs extending from the second side of the extruded sheet, the nibs having a predetermined coefficient of friction when operatively engaged to a carpeted interior floor of a vehicle to prevent the floor mat from shifting relative thereto;
applying an electromagnetic frequency having a wavelength between 8 kHz and 35,000 MHz to a predetermined section of the second side to remove the nibs therefrom and provide at least one smooth area thereon;
cutting the laminate into a predetermined shape having a peripheral edge, wherein at least one smooth area is disposed along the peripheral edge; and
serging the peripheral edge of the predetermined shape to provide a floor mat having a serged edge border that conceals the bond joint between the top layer and bottom layer and facilitates the bond therebetween.

16. The method as set forth in claim 15 wherein said step of bonding the fabric sheet to the extruded sheet in a press to form a laminate further includes:
placing the extruded sheet and fabric sheet between first and second rollers where at least one of the rollers including a plurality of cavities adapted to receive a portion of the extruded sheet;
cycling the extruded sheet and fabric sheet between the first and second rollers such that pressure is applied to define a laminate and a portion of the extruded sheet operatively engages the plurality of cavities to define a plurality of nibs extending from the second side; and
removing the laminate from between the first and second rollers.

17. The method as set forth in claim 15 wherein said step of applying the fabric sheet to the first side of the extruded sheet while the extruded sheet remains tacky further includes at least one of the following steps:
placing the scrim subsurface into contact with the first side of the extruded sheet after applying an adhesive to the first side;
placing the scrim subsurface into contact with the first side of the extruded sheet after applying an adhesive to the scrim subsurface; and
placing the scrim subsurface into contact with the first side of the extruded sheet after heating the scrim subsurface.

18. The method as set forth in claim 15 further includes the step of cutting the laminate into at least one blank prior to said step of applying the electromagnetic frequency to facilitate the application of the electromagnetic frequency to a predetermined area of the second side.

19. The method as set forth in claim 15 wherein said step of applying the electromagnetic frequency further includes applying an ultrasonic weld having a frequency between 8 kHz and 17 kHz to the second side of the extruded sheet to melt the nibs within the predetermined section and provide a smooth area adapted to receive a serged edge border.

20. The method as set forth in claim 15 wherein said step of applying an electromagnetic frequency further includes applying a dielectric weld having a radio frequency between 29 kHz and 35,000 MHz to the second side of the extruded sheet to melt the nibs within the predetermined section and provide a smooth area adapted to receive a serged edge border.

21. The method as set forth in claim 15 wherein said step of cutting the laminate into a predetermined shape further includes the steps of:
placing the laminate between first and second rollers where at least one of the rollers includes at least one cutting preform having an outline corresponding to the predetermined shape of at least the floor mat;
cycling the laminate between the first and second rollers such that the cutting preform cuts the laminate to impart the a predetermined shape onto the laminate; and
removing the predetermined shape defined by the cutting preform from between the first and second rollers.

22. The method as set forth in claim 15 wherein said step of cutting the laminate into a predetermined shape further includes the steps of:
placing the laminate into a mold having a die corresponding to the predetermined shape of at least one floor mat;
stamping the die into the laminate to cut the laminate into at least one predetermined shape; and
removing the predetermined shape defined by the die from the mold.

23. The method as set forth in claim 22 wherein said step of applying the electromagnetic frequency to provide at least one smooth area occurs simultaneously with said step of stamping the die into the laminate.

24. A method of manufacturing a floor mat for the interior of a vehicle, said method comprising the steps of:
extruding a thermoplastic material into a sheet having a first side and a second side opposite the first side, the extruded sheet having flexible quality when cured and adapted to define the bottom layer of a floor mat;
applying a fabric sheet to the first side of the extruded sheet while the extruded sheet remains tacky, where the fabric sheet is adapted to define the top layer of a floor mat and includes a scrim subsurface to operatively engage the first side and a carpeted super-surface;
bonding the fabric sheet to the extruded sheet in a press to form a laminate, where the press includes a surface adapted to impart at least one predetermined design onto the second side of the extruded sheet and the predetermined design includes a plurality of nibs surrounded by a smooth area, and where the nibs have a predetermined coefficient of friction when operatively engaged to a carpeted interior floor of a vehicle to prevent the floor mat from shifting relative thereto;
cutting the laminate into at least one predetermined shape corresponding to the predetermined design, where the predetermined shape is adapted for use as a vehicle floor mat and includes a peripheral edge wherein the smooth area is disposed along the peripheral edge; and
dressing the peripheral edge with a border to provide a floor mat having a dressed edge that conceals the joint between the top layer and the bottom layer and facilitates the bond therebetween.

25. The method as set forth in claim 24 wherein said step of bonding the fabric sheet to the extruded sheet in a press to form a laminate further includes:
placing the extruded sheet and fabric sheet between first and second rollers where the surface of one of the rollers includes a mold having at least one predetermined design defined by a plurality of cavities surrounded by a smooth area, and where the cavities are adapted to receive a portion of the extruded sheet;
cycling the extruded sheet and fabric sheet between the first and second rollers, such that pressure is applied to define a laminate having at least one predetermined design defined by a plurality of nibs surrounded by a smooth area along the second side; and
extracting the laminate from between the first and second rollers.

26. The method as set forth in claim 24 wherein said step of applying the fabric sheet to the first side of the extruded sheet while the extruded sheet remains tacky further includes at least one of the following steps:
placing the scrim subsurface into contact with the first side of the extruded sheet after applying an adhesive to the first side;
placing the scrim subsurface into contact with the first side of the extruded sheet after applying an adhesive to the scrim subsurface; and
placing the scrim subsurface into contact with the first side of the extruded sheet after heating the scrim subsurface.

27. The method as set forth in claim 24 wherein said step of cutting the laminate into at least one predetermined shape further includes the steps of:
placing the laminate between first and second rollers where at least one of the rollers includes at least one cutting preform having an outline corresponding to the predetermined design;
cycling the laminate sheet between the first and second rollers such that the cutting preform cuts the laminate along the outline to define a predetermined shape having a peripheral edge onto the laminate corresponding to the predetermined design; and
removing the predetermined shape defined by the cutting preform from between the first and second rollers.

28. The method as set forth in claim 24 wherein said step of cutting the laminate into a predetermined shape further includes the steps of:
placing the laminate into a mold having a die corresponding to the predetermined design;
stamping the die into the laminate to cut the laminate into at least one predetermined shape having a peripheral edge corresponding to the predetermined design; and
removing the predetermined shape defined by the die from the mold.

29. The method as set forth in claim 24 wherein said step of dressing the peripheral edge of the predetermined shape further includes the step of serging the peripheral edge of the predetermined shape to provide a floor mat having a serged edge border.

30. The method as set forth in claim 24 wherein said step of dressing the peripheral edge of the predetermined shape further includes the steps of:
applying a fabric binding tape to the peripheral edge of the predetermined shape; and
stitching the binding tape to the predetermined shape to provide a floor mat having a tape edge border.

31. The method as set forth in claim 24 wherein said step of dressing the peripheral edge of the predetermined shape further includes the steps of:
applying a polymer sleeve to the peripheral edge of the predetermined shape; and
stitching the polymer sleeve to the peripheral edge to provide a floor mat having a tape edge border.

32. A floor mat for the interior of a vehicle comprising:
an extruded thermoplastic bottom layer having a first side and a second side opposite said first side, said second side having a plurality of nibs extending therefrom and at least one smooth area, said nibs having a predetermined coefficient of friction when operatively engaged to a carpeted interior floor of a vehicle to prevent the floor mat from shifting relative thereto;
a fabric top layer having a carpeted super-surface defining a Class-A surface that is visible from the interior of a vehicle and a scrim subsurface bonded to said first side while said extruded thermoplastic bottom layer remains tacky, said bottom layer and said top layer cooperating to define a laminate having a predetermined shape including a peripheral edge, said smooth area disposed adjacent said peripheral edge; and
a woven border secured to said peripheral edge to provide a dressed edge that conceals the joint between said bottom layer and said top layer and facilitates the bond therebetween,
wherein said nibs are defined on said second side by a mold surface having a plurality of cavities after the application of pressure to said bottom layer in a mold while said bottom layer remains tacky and said smooth area is defined on said second side by the application of an electromagnetic frequency having a wavelength between 8 kHz and 35,000 MHz to a predetermined section of the second side to remove the nibs therefrom.

33. The floor mat as set forth in claim 32 wherein said carpeted super-surface includes a heel pad adapted to provide additional wear resistance and a grommet to operatively engage a protrusion located within a vehicle interior floor to further prevent shifting of said floor mat relative the vehicle interior floor.

34. The floor mat as set forth in claim 32 wherein said woven border is a serged edge having a thread material that operatively engages a portion of said top layer and said bottom layer to conceal said peripheral edge from view.

35. The floor mat as set forth in claim 32 wherein said woven border is a tape edge having a binder tape that conceals said peripheral edge from view and stitching that operatively engages a portion of said top layer and said bottom layer to secure said binder tape to said peripheral edge.

36. The floor mat as set forth in claim 32 wherein said carpeted super-surface is a tufted carpet material.

37. The floor mat as set forth in claim 32 wherein said carpeted super-surface is a pile carpet material.
